(19) United States
(12) Patent Application Publication
(10) Pub. No.: US 2002/0156307 A1
(43) Pub. Date: Oct. 24, 2002

(54) Catalyst mixture for the isomerization of dichlorobutenes

(76) Inventor: Peter Schertl, Marl (DE)

Correspondence Address: BAYER CORPORATION, PATENT DEPARTMENT, 100 BAYER ROAD, PITTSBURGH, PA, 15205, US

(21) Appl. No.: 10/077,430

(22) Filed: Feb. 15, 2002

(30) Foreign Application Priority Data
Feb. 22, 2001 (DE) 10108619.9

(51) Int. Cl. C07F 1/10

(52) U.S. Cl. 556/9; 556/110

(57) ABSTRACT

The invention relates to a composition producible by mixing an aromatic amine or several aromatic amines of the general formula I,

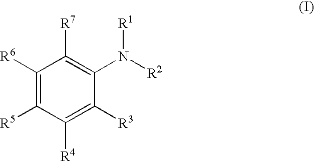

Wherein

R¹ to R⁷, independently of one another, denote H, C₁ to C₁₂ alkyl, C₅ to C₈ cycloalkyl, C₆ to C₁₄ aryl, alkylaryl, arylalkyl, with two adjacent groups together optionally forming saturated or unsaturated C₃ to C₁₄ cycles, or —SiR⁸R⁹R¹⁰, wherein R⁸ to R¹⁰, independently of one another, can represent C₁ to C₄ alkyl, C₅ to C₈ cycloalkyl or C₆ to C₁₄ aryl,

with an anhydrous copper salt CuXₙ, wherein n=1 or 2 and X=halide, sulfate, acetate, acetylacetonate, or a mixture of two or more of these compounds in 1,4-dichloro-2-butene or 3,4-dichloro-1-butene, a process for the production thereof, its use as a catalyst and a process for the isomerization of 1,4-dichloro-2-butene to 3,4-dichloro-1-butene or vice versa using the composition according to the invention.

### FIELD OF THE INVENTION

The invention relates to a composition producible by mixing an aromatic amine or several aromatic amines of the general formula I,

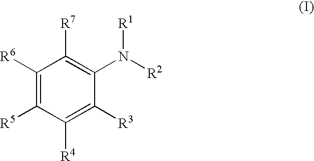

Wherein

R¹ to R⁷, independently of one another, denote H, C₁ to C₁₂ alkyl, C₅ to C₈ cycloalkyl, C₆ to C₁₄ aryl, alkylaryl, arylalkyl, with two adjacent groups together optionally forming saturated or unsaturated C₃ to C₁₄ cycles, or —SiR⁸R⁹R¹⁰, wherein R⁸ to R¹⁰, independently of one another, can represent C₁ to C₄ alkyl, C₅ to C₈ cycloalkyl or C₆ to C₁₄ aryl,

With an anhydrous copper salt CuXₙ, wherein n=1 or 2 and X=halide, sulfate, acetate, acetylacetonate, naphthenate or a mixture of two or more of these copper salts in 1,4-dichloro-2-butene or 3,4-dichloro-1-butene, a process for the production thereof, its use as a catalyst and a process for the isomerization of 1,4-dichloro-2-butene to 3,4-dichloro-1-butene or vice versa using the composition according to the present invention.

### BACKGROUND OF THE INVENTION

3,4-Dichloro-1-butene is an important intermediate in the production of 2-chloroprene, which is used industrially as a monomer for the production of polychloroprene rubber.

In the chlorination of butadiene, a mixture of cis-1,4-dichloro-2-butene, trans-1,4-dichloro-2-butene and 3,4-dichloro-1-butene, containing approximately 65% cis- and trans-1,4-dichloro-2-butene and approximately 35% 3,4-dichloro-1-butene, is formed. These isomers are generally present in the mixture in equilibrium, the ratio being dependent on the production conditions. For the sake of simplicity, cis- and trans-1,4-dichloro-2-butene will be referred to below jointly as 1,4-dichloro-2-butene. Because of the different boiling points (1,4-dichloro-2-butene: 154-9° C. and 3,4-dichloro-1-butene: 123° C.), this mixture can be separated by distillation. Since only 3,4-dichloro-1-butene is suitable for the production of 2-chloroprene, the 1,4-dichloro-2-butene must be isomerized to 3,4-dichloro-1-butene and recycled into the process.

The conventional processes for the isomerization of 1,4-dichloro-2-butene to 3,4-dichloro-1-butene or vice versa are based on the use of suitable isomerization catalysts, which ensure a rapid adjustment of equilibrium between the isomers into 1,4-dichloro-2-butene or 3,4-dichloro-1-butene at elevated temperatures. In most processes, metal salts of copper are used in the presence of basic additives, which serve to increase the rates of reaction.

DE-A-21 38 790 discloses a process for the isomerization of 1,4-dichloro-2-butene to 3,4-dichloro-1-butene or vice versa at 80 to 160° C. using copper naphthenate, dinitrile and amide. In DE-A-21 43 157, a process for the isomerization in the presence of copper salts and oxime derivatives at 80 to 160° C. is described. DE-A-22 00 780 claims a process containing a mixture of a copper compound and an organic phosphorus compound as catalyst. DE-A-21 07 468 discloses the use of copper naphthenate and nitro compounds, DE-A-21 30 488 the use of copper naphthenate and nitroanilines. In DE-A-22 12 235, an isomerization process using copper compound and urea derivative is described. DE-A-22 06 971 claims the use of a mixture of copper compound (copper(II) stearate, oleate and naphthenate) and chlorine-containing aniline derivative. In U.S. Pat. No. 4,895,993, a process for isomerization in the presence of a catalyst consisting of a copper compound and a dithiocarbamate or trithiocarbonate derivative is disclosed .

Rostovshchikova et al., in Zh. Obshch. Khim. 1994, 64, 12, describes the use of triphenylphosphine or, in Kinet. Katal. 1992, 33, 314, the use of different dialkyl sulfides in the presence of copper halides for catalytic isomerization. Asatryan et al., in Arm. Khim. Zh. 1988, 41, 278, investigated the action of macrocyclic polyethers or polyethylene glycols and, in Arm. Khim. Zh. 1988, 41, 273, the influence of benzonitrile, nitrobenzene, DMF, dimethyl sulfone or acetophenone.

A disadvantage of these processes is that the velocities of transformation are comparatively low and a large quantity of undesirable by-products is formed.

In Arm. Khim. Zh. 1987, 40, 709, Asatryan et al. describe different isomerization catalysts based on halide salts of copper, iron or zinc in the presence of amine derivatives such as triethylamine, diethylamine, triethanolamine, ethylenediamine or aniline. However, Asatryan et al. describes the fact that aliphatic amines lead to isomerization catalysts which, owing to their greater nucleophilicity, display greater effectiveness than aromatic amines. The use of aliphatic amines is therefore recommended there.

Now, the object of the present invention was to find an economical process for the isomerization of 1,4-dichloro-2-butene to 3,4-dichloro-1-butene or vice versa using a catalyst system that guarantees high velocities of transformation and catalyzes the isomerization with reduced by-product formation.

Surprisingly, it has been found that, in a process for the isomerization of 1,4-dichloro-2-butene to 3,4-dichloro-1-butene or vice versa, wherein the process uses a composition that can be produced by mixing an aromatic amine and a copper salt, contrary to the findings of Asatryan et al. in Arm. Khim. Zh. 1987, 40, 709, the rate of isomerization is higher, the by-product formation is lower due to the lower basicity of the aromatic amines and thus, the process is more economical.

### SUMMARY OF THE INVENTION

The present invention provides a composition producible by mixing an aromatic amine or several aromatic amines of the general formula I,

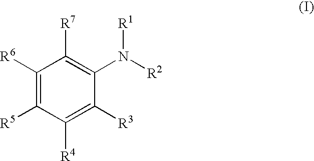

Wherein

R¹ to R⁷, independently of one another, denote H, C₁ to C₁₂ alkyl, C₅ to C₈ cycloalkyl, C₆ to C₁₄ aryl, alkylaryl, arylalkyl, with two adjacent groups together optionally forming saturated or unsaturated C₃ to C₁₄ cycles, or —SiR⁸R⁹R¹⁰, wherein R⁸ to R¹⁰, independently of one another, can represent C₁ to C₄ alkyl, C₅ to C₈ cycloalkyl or C₆ to C₁₄ aryl,

With an anhydrous copper salt CuXₙ, wherein n=1 or 2 and X=halide, sulfate, acetate, acetylacetonate or naphthenate, or a mixture of two or more of these copper salts.

### DETAILED DESCRIPTION OF THE INVENTION

C₁-C₁₂ alkyl means all linear or branched, saturated or unsaturated alkyl groups with 1 to 12 C atoms known to the person skilled in the art, such as methyl, ethyl, n-propyl, i-propyl, n-butyl, i-butyl, t-butyl, n-pentyl, i-pentyl, neo-pentyl, n-hexyl, i-hexyl, heptyl, octyl, nonyl, decyl, undecyl and dodecyl and the unsaturated homologues thereof.

C₅ to C₈ cycloalkyl means all cyclic alkyl groups with 5 to 8 C atoms known to the person skilled in the art, such as cyclopentyl, cyclohexyl, cycloheptyl, cyclooctyl and the unsaturated homologues thereof.

C₆ to C₁₄ aryl means all aryl groups with 6 to 14 C atoms known to the person skilled in the art, such as phenyl, naphthenyl, fluorenyl, anthracenyl and phenanthranyl.

Preferred aromatic amines are aniline, N,N-dimethylaniline, p-toluidine or mixtures of 2 or 3 of these components.

The molar ratio of the two components CuXₙ, wherein n=1 or 2 and X=halide, sulfate, acetate, acetylacetonate, naphthenate, to aromatic amine is advantageously in the range of 1:0.5 to 1.5, preferably 1:0.7 to 1:1. The concentration of the two components is advantageously in the range of 10⁻³ to 1 mol/l, preferably between 5×10⁻² to 5×10⁻¹ mol Cu/l.

The present invention further relates to a process for the production of a composition according to the present invention, wherein the components are mixed in the order: aromatic amine or amines and then the anhydrous copper salt or salts. It is advantageous to perform this mixing process under a protective atmosphere, such as a nitrogen or argon atmosphere, in a temperature range of 30 to 180° C., preferably 50 to 150° C.

The present invention further relates to the use of the composition according to the present invention as a catalyst, particularly as a catalyst in a process for the isomerization of 1,4-dichloro-2-butene to 3,4-dichloro-1-butene or of 3,4-dichloro-1-butene to 1,4-dichloro-2-butene.

Thus, the invention further provides a process for the isomerization of 1,4-dichloro-2-butene to 3,4-dichloro-1-butene or of 3,4-dichloro-1-butene to 1,4-dichloro-2-butene, wherein

a) at a temperature of 30 to 180° C., preferably in the range of 50° to 150° C., an aromatic amine or several aromatic amines of the general formula I,

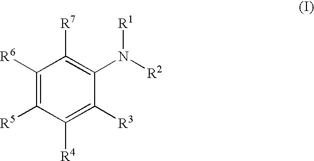

wherein

R¹ to R⁷, independently of one another, denote H, C₁ to C₁₂ alkyl, C₅ to C₈ cycloalkyl, C₆ to C₁₄ aryl, alkylaryl, arylalkyl, with two adjacent groups together optionally forming saturated or unsaturated C₃ to C₁₄ cycles, or —SiR⁸R⁹R¹⁰, wherein R⁸ to R¹⁰, independently of one another, can represent C₁ to C₄ alkyl, C₅ to C₈ cycloalkyl or C₆ to C₁₄ aryl,

and an anhydrous copper salt CuXₙ, wherein n=1 or 2 and X=halide, sulfate, acetate, acetylacetonate, naphthenate or a mixture of two or more of these compounds, are added to 1,4-dichloro-2-butene, 3,4-dichloro-1-butene or a mixture thereof,

b) the reaction solution is allowed to react until an equilibrium has become established between 1,4-dichloro-2-butene and 3,4-dichloro-1-butene, preferably between 1 and 180 minutes, more preferably between 15 and 45 minutes,

c) a mixture of 1,4-dichloro-2-butene and 3,4-dichloro-1-butene is continuously removed and this is then separated by distillation,

d) the undesirable component from the distillation performed in c) is fed back into the reaction system,

e) and optionally, simultaneously with c), 1,4-dichloro-2-butene and/or 3,4-dichloro-1-butene is fed into the reaction system.

The process can take place, either batchwise or continuously, between 0.01 bar and 10 bar, preferably between 0.1 and 1.0 bar, it being recommended that a more highly concentrated solution of the catalyst system, preferably 10⁻¹ to 1 mol Cu/l, in 1,4-dichloro-2-butene and/or 3,4-dichloro-1-butene should first be produced and this should be added continuously to a larger quantity of 1,4-dichloro-2-butene and/or 3,4-dichloro-1-butene, so that the desired concentration, preferably 5×10⁻² to 5×10⁻¹ mol Cu/l of the catalyst is obtained, 1,4-dichloro-2-butene and/or 3,4-dichloro-1-butene being fed in continuously and a mixture of 1,4-dichloro-2-butene and 3,4-dichloro-1-butene being removed continuously and then separated by distillation.

The invention is explained in more detail below, with the aid of examples of embodiments, without these being limited to the examples, however.

### EXAMPLES

Preparation of the Catalyst Mixes

Catalyst Mix A

Under a nitrogen atmosphere, 232.0 g of 1,4-dichloro-2-butene are placed in a 500 ml round-bottom flask with an internal thermometer, reflux condenser and pressure relief valve, 9.67 g (104 mmol) of aniline are added at 50° C. and stirring is performed at this temperature for 4 h. 10.29 g (104 mmol) of copper(I) chloride are then added at 50° C. and stirring is performed at this temperature for a further 8 h.

Catalyst Mix B

232.0 g of 1,4-dichloro-2-butene are placed in the apparatus described in the production of catalyst A under nitrogen, 8.72 g (94 mmol) of aniline are added at 50° C. and stirring is performed at this temperature for 4 h. 10.29 g (104 mmol) of copper(I) chloride are then added at 50° C. and stirring is performed at this temperature for a further 8 h.

Catalyst Mix C

232.0 g of 1,4-dichloro-2-butene are placed in the apparatus described in the production of catalyst A under nitrogen, 7.75 g (83 mmol) of aniline are added at 50° C. and stirring is performed at this temperature for 4 h. 10.29 g (104 mmol) of copper(I) chloride are then added at 50° C. and stirring is performed at this temperature for a further 8 h.

Catalyst D

232.0 g of 1,4-dichloro-2-butene are placed in the apparatus described in the production of catalyst A under nitrogen, 6.78 g (73 mmol) of aniline are added at 50° C. and stirring is performed at this temperature for 4 h. 10.29 g (104 mmol) of copper(I) chloride are then added at 50° C. and stirring is performed at this temperature for a further 8 h.

Catalyst Mix E

232.0 g of 1,4-dichloro-2-butene are placed in the apparatus described in the production of catalyst A under nitrogen, 11.34 g (94 mmol) of N,N-dimethylaniline are added at 50° C. and stirring is performed at this temperature for 4 h. 10.29 g (104 mmol) of copper(I) chloride are then added at 50° C. and stirring is performed at this temperature for a further 8 h.

Catalyst Mix F

232.0 g of 1,4-dichloro-2-butene are placed in the apparatus described in the production of catalyst A under nitrogen, 15.84 g (94 mmol) of diphenylamine are added at 50° C. and stirring is performed at this temperature for 4 h. 10.29 g (104 mmol) of copper(I) chloride are then added at 50° C. and stirring is performed at this temperature for a further 8 h.

Catalyst Mix G

232.0 g of 1,4-dichloro-2-butene are placed in the apparatus described in the production of catalyst A under nitrogen, 10.52 g (104 mmol) of triethylamine are added at 50° C. and stirring is performed at this temperature for 4 h. 10.29 g (104 mmol) of copper(I) chloride are then added at 50° C. and stirring is performed at this temperature for a further 8 h.

Catalyst Mix H

232.0 g of 1,4-dichloro-2-butene are placed in the apparatus described in the production of catalyst A under nitrogen, 9.47 g (94 mmol) of triethylamine are added at 50° C. and stirring is performed at this temperature for 4 h. 10.29 g (104 mmol) of copper(I) chloride are then added at 50° C. and stirring is performed at this temperature for a further 8 h.

Catalyst Mix I

232.0 g of 1,4-dichloro-2-butene are placed in the apparatus described in the production of catalyst A under nitrogen, 7.37 g (73 mmol) of triethylamine are added at 50° C. and stirring is performed at this temperature for 4 h. 10.29 g (104 mmol) of copper(I) chloride are then added at 50° C. and stirring is performed at this temperature for a further 8 h.

Performing the Isomerization Reactions

### Example 1

Under nitrogen, 240.0 g of 1,4-dichloro-2-butene are placed in a 500 ml round-bottom flask with an internal thermometer, reflux condenser and pressure relief valve, 84.0 g of the catalyst mix A obtained at room temperature are added at 130° C. so that, with vigorous stirring, a mix temperature of 150° C. is established, and stirring is performed at this temperature for 90 min.

During the reaction period, samples are taken at fixed intervals and investigated by gas chromatography for their content of 3,4-dichloro-1-butene, cis-1,4-dichloro-2-butene, trans-1,4-dichloro-2-butene and any by-products formed, such as 1-chloroprene. The starting point of the reaction is fixed as the end of the addition of the catalyst mix. Samples of approx. 2 ml in volume each are taken at the starting point and after 5, 15, 30 and 90 minutes.

### Example 2

240.0 g of 1,4-dichloro-2-butene are placed in the test set-up described in example 1, 84.0 g of the catalyst mix B are added at 130° C. so that a mix temperature of 105° C. is established, and stirring is performed at this temperature for 90 min. The timing, sampling and investigation of the samples are as explained in example 1.

### Example 3

240.0 g of 1,4-dichloro-2-butene are placed in the test set-up described in example 1, 84.0 g of the catalyst mixture C are added at 130° C. so that a mix temperature of 150° C. is established, and stirring is performed at this temperature for 90 min. The timing, sampling and investigation of the samples are as explained in example 1.

### Example 4

240.0 g of 1,4-dichloro-2-butene are placed in the test set-up described in example 1, 84.0 g of the catalyst mix D are added at 130° C. so that a mix temperature of 105° C. is established, and stirring is performed at this temperature for 90 min. The timing, sampling and investigation of the samples are as explained in example 1.

### Example 5

240.0 g of 1,4-dichloro-2-butene are placed in the test set-up described in example 1, 84.0 g of the catalyst mix E are added at 130° C. so that a mix temperature of 105° C. is established, and stirring is performed at this temperature for 90 min. The timing, sampling and investigation of the samples are as explained in example 1.

### Example 6

240.0 g of 1,4-dichloro-2-butene are placed in the test set-up described in example 1, 84.0 g of the catalyst mix F are added at 130° C. so that a mix temperature of 105° C. is established, and stirring is performed at this temperature for 90 min. The timing, sampling and investigation of the samples are as explained in example 1.

### Example 7

240.0 g of 1,4-dichloro-2-butene are placed in the test set-up described in example 1, 84.0 g of the catalyst mix G are added at 130° C. so that a mix temperature of 105° C. is established, and stirring is performed at this temperature for 90 min. The timing, sampling and investigation of the samples are as explained in example 1.

### Example 8

240.0 g of 1,4-dichloro-2-butene are placed in the test set-up described in example 1, 84.0 g of the catalyst mix H are added at 130° C. so that a mix temperature of 105° C. is established, and stirring is performed at this temperature for 90 min. The timing, sampling and investigation of the samples are as explained in example 1.

### Example 9

240.0 g of 1,4-dichloro-2-butene are placed in the test set-up described in example 1, 84.0 g of the catalyst mix I are added at 130° C. so that a mix temperature of 150° C. is established, and stirring is performed at this temperature for 90 min. The timing, sampling and investigation of the samples are as explained in example 1.

### Example 10

240.0 g of 1,4-dichloro-2-butene are placed in the test set-up described in example 1, 84.0 g of the catalyst mix H are added at 165° C. so that a mix temperature of 130° C. is established, and stirring is performed at this temperature for 90 min. The timing, sampling and investigation of the samples are as explained in example 1.

| | | | | Molar | | | | | | | |
|---|---|---|---|---|---|---|---|---|---|---|---|
| | Catalyst mix | | | ratio | | Content [%] | | | | | |
| | | Copper | | Copper | Temperature | 3,4-dichloro-1-butene | | | | | 1-chloroprene |
| Example | | salt | Base | salt/base | [° C.] | 0 min | 5 min | 15 min | 30 min | 90 min | 90 min |
| 1 | A | CuCl | Aniline | 1:1 | 105 | 6.99 | 13.72 | 17.40 | 18.78 | 20.40 | 0.21 |
| 2 | B | CuCl | Aniline | 1:0.9 | 105 | 8.17 | 14.54 | 17.62 | 19.40 | 21.58 | 0.52 |
| 3 | C | CuCl | Aniline | 1:0.8 | 105 | 9.20 | 13.26 | 16.77 | 19.84 | 21.16 | 0.43 |
| 4 | D | CuCl | Aniline | 1:0.7 | 105 | 6.86 | 13.15 | 17.98 | 20.87 | 21.18 | 0.29 |
| 5 | E | CuCl | N,N-dimethyl- | 1:0.9 | 105 | 7.45 | 13.6 | 16.08 | 17.27 | 19.38 | n.d. |
| | | | aniline | | | | | | | | |
| 6 | F | CuCl | Diphenylamine | 1:0.9 | 105 | 8.24 | 11.01 | 15.75 | 18.96 | 19.09 | 0.34 |
| 7 | G | CuCl | Triethylamine | 1:1 | 105 | 7.01 | 7.58 | 9.58 | 11.89 | 16.05 | n.d. |
| 8 | H | CuCl | Triethylamine | 1:0.9 | 105 | 8.40 | 14.36 | 16.77 | 16.89 | 17.06 | 0.93 |
| 9 | I | CuCl | Triethylamine | 1:0.7 | 105 | 9.19 | 12.82 | 13.61 | 13.76 | 14.37 | n.d. |
| 10 | H | CuCl | Triethylamine | 1:0.9 | 130 | 9.54 | 15.47 | n.d. | 17.82 | 18.13 | 2.73 |

n.d. = not determined

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composition producible by mixing an aromatic amine or several aromatic amines of the general formula I, 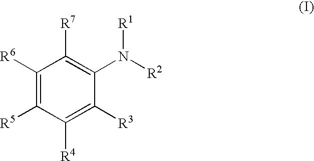
Wherein
R¹ to R⁷, independently of one another, denote H, C₁ to C₁₂ alkyl, C₅ to C₈ cycloalkyl, C₆ to C₁₄ aryl, alkylaryl, arylalkyl, with two adjacent groups together optionally forming saturated or unsaturated C₃ to C₁₄ cycles, or —SiR⁸R⁹R¹⁰, wherein R⁸ to R¹⁰, independently of one another, can represent C₁ to C₄ alkyl, C₅ to C₈ cycloalkyl or C₆ to C₁₄ aryl,
with an anhydrous copper salt CuXₙ, wherein n=1 or 2 and X=halide, sulfate, acetate, acetylacetonate, naphthenate, or a mixture of two or more of these copper salts.

2. A composition according to claim 1, wherein aniline, N,N-dimethylaniline, p-toluidine or mixtures of 2 or 3 of these components are used as the amine.

3. A composition according to claim 1, wherein the molar ratio of the two components copper salt/copper salts to aromatic amine/amines is in the range of 1:0.5 to 1.5.

4. A composition according to claim 1, wherein the concentration of the components copper salt/copper salts and aromatic amine/amines is in the range of 10⁻³ to 1 mol/l.

5. A catalyst comprising a composition producible by mixing an aromatic amine or several aromatic amines of the general formula I, 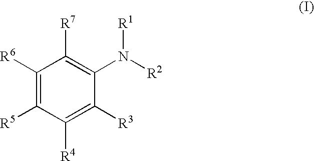
Wherein
R¹ to R⁷, independently of one another, denote H, C₁ to C₁₂ alkyl, C₅ to C₈ cycloalkyl, C₆ to C₁₄ aryl, alkylaryl, arylalkyl, with two adjacent groups together optionally forming saturated or unsaturated C₃ to C₁₄ cycles, or —SiR⁸R⁹R¹⁰, wherein R⁸ to R¹⁰, independently of one another, can represent C₁ to C₄ alkyl, C₅ to C₈ cycloalkyl or C₆ to C₁₄ aryl,
with an anhydrous copper salt CuXₙ, wherein n=1 or 2 and X=halide, sulfate, acetate, acetylacetonate, naphthenate, or a mixture of two or more of these copper salts.

6. A process for the isomerization of 1,4-dichloro-2-butene to 3,4-dichloro-1-butene or of 3,4-dichloro-1-butene to 1,4-dichloro-2-butene, comprising the step of
a) adding, at a temperature of 30 to 180° C., an aromatic amine or several aromatic amines of the general formula I, 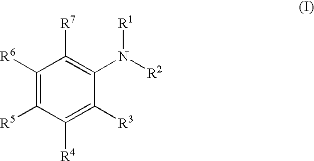
wherein
R¹ to R⁷, independently of one another, denote H, C₁ to C₁₂ alkyl, C₅ to C₈ cycloalkyl, C₆ to C₁₄ aryl, alkylaryl, arylalkyl, with two adjacent groups together optionally forming saturated or unsaturated C₃ to C₁₄ cycles, or —SiR⁸R⁹R¹⁰, wherein R⁸ to R¹⁰, independently of one another, can represent C₁ to C₄ alkyl, C₅ to C₈ cycloalkyl or C₆ to C₁₄ aryl,
and an anhydrous copper salt CuXₙ, wherein n=1 or 2 and X=halide, sulfate, acetate, acetylacetonate, or a mixture of two or more of these copper salts, to 1,4-dichloro-2-butene, 3,4-dichloro-1-butene or a mixture thereof,
b) allowing the reaction solution to react until an equilibrium has become established between 1,4-dichloro-2-butene and 3,4-dichloro-1-butene,
c) continuously removing a mixture of 1,4-dichloro-2-butene and 3,4-dichloro-1-butene and then separating by distillation,
d) feeding back the undesirable component from the distillation performed in c) into the reaction system,
e) and optionally, simultaneously with c), feeding 1,4-dichloro-2-butene and/or 3,4-dichloro-1-butene into the reaction system.

7. A process according to claim 6, wherein the temperature in step a) is in the range of 50 to 150° C.

8. A process according to claim 6, wherein the reaction period in step b) is in the range of 15 and 45 minutes.

9. A process according to claim 6, wherein in step a), the composition of amines is used in concentrations in the range of 10⁻¹ to 1 mole Cu/l in 1,4-dichloro-2-butene and/or 3,4-dichloro-1-butene and this is added to 1,4-dichloro-2-butene, 3,4-dichloro-1-butene or a mixture thereof.

10. A process for the production of a composition comprising the step of mixing an aromatic amine or several aromatic amines of the general formula I, 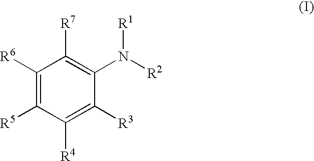
wherein
R¹ to R⁷, independently of one another, denote H, C₁ to C₁₂ alkyl, C₅ to C₈ cycloalkyl, C₆ to C₁₄ aryl, alkylaryl, arylalkyl, with two adjacent groups together optionally forming saturated or unsaturated C₃ to C₁₄ cycles, or —SiR⁸R⁹R¹⁰, wherein R⁸ to R¹⁰, independently of one another, can represent C₁ to C₄ alkyl, C₅ to C₈ cycloalkyl or C₆ to C₁₄ aryl,
with an anhydrous copper salt CuXₙ, wherein n=1 or 2 and X=halide, sulfate, acetate, acetylacetonate, naphthenate, or a mixture of two or more of these copper salts, wherein the individual components are mixed together.
